(19) United States
(12) Patent Application Publication
(10) Pub. No.: US 2023/0167674 A1
(43) Pub. Date: Jun. 1, 2023

(54) Replacement Weather Seal for A Garage Door

(71) Applicant: Gordon H Hess, Pueblo, CO (US)

(72) Inventor: Gordon H Hess, Pueblo, CO (US)

(21) Appl. No.: 17/539,988

(22) Filed: Dec. 1, 2021

(51) Int. Cl. E06B 7/23; E06B 1/52

(52) U.S. Cl. CPC E06B 7/2316; E06B 1/522

(57) ABSTRACT

A replacement weather seal for use with a garage door having an existing two-part weather seal previously installed on the garage door. The existing weather seal has a rigid base fastened to a support frame surrounding the garage door, and a flexible combination cover and flap portion integral with the rigid base. The replacement weather seal replaces the flap portion of the existing seal but leaves the rigid base that is fastened to the support frame. The replacement weather seal comprises a main body which attaches to the rigid of the existing weather seal. Two sealing flaps are integrally molded to opposite edges of the main body, which flaps deflect and form a weather-tight seal with both the garage door and the existing rigid base. An L-shaped curb structure connects with the main body and positions the replacement weather seal on the existing weather seal rigid base.

### BACKGROUND OF THE INVENTION

### Field of the Invention

The present invention relates to a replacement weather seal for use in sealing a gap between a perimeter of a garage door and a garage door frame, and more particularly, to a weather seal for an overhead, roll-up type garage door.

### Description of Related Art Including Information Disclosed Under 37 CFR 1.97 and 37 CFR 1.98

Frequently it is desirable to replace a weather seal that is used to seal a gap between a garage door and a garage door frame. Conventional garage door weather seals are combination door stops and flexible seals. Most of these weather seals have a rigid base with a flexible sealing flap. The sealing flap generally protrudes from the rigid base at an angle to contact the garage door and seal the gap.

A disadvantage with the rigid base seal is that the seal must be sold in pre-cut lengths. This makes the rigid base seal costly. Another disadvantage is that the rigid base seal cannot be rolled up into a coil, which makes the seal cumbersome to package and transport.

Yet another disadvantage with the rigid base seal is that the flexible sealing flap will deteriorate from exposure to the environment. The sealing flap will lose its elasticity from environmental exposure and will no longer seal tightly to the garage door.

In response to the seal deterioration problem, a typical repair is to replace the combination door stop and flexible seal with a similar door stop and flexible seal. This repair can be costly as it requires vehicles capable of transporting the rigid base weather seal, carpentry to install the rigid base weather seal, and painting the rigid base seal to match the existing garage door frame.

Another repair for the seal deterioration problem is to use a coilable replacement seal. A coilable seal is easy to transport and to install. The coilable replacement seal is typically installed with exposed fasteners. The fasteners are driven through the visible side of the coilable replacement seal into the door frame or driven into the base of the existing combination door stops and flexible seal. A disadvantage of the coilable seal is that the exposed fasteners are unattractive. Another disadvantage of the coilable replacement seal is that the seal will expand and contract with temperature changes and cause air gaps between the fasteners.

U.S. Pat. No. 4,447,988 issued May 15, 1984, by Cole et al. for Garage Door Weather Seal discloses a garage door weather seal for use on a garage having a door with a planar outside surface and a door frame including a surface normal to the plane of the garage door when closed. The seal comprises a main body portion which lies in a plane extending at an angle to both the door and door frame surfaces when installed. Sealing lips integrally molded to opposite edges of the main body portion form a weather-tight seal with both the surface of the garage door and the surface of the door frame. An L-shape leg structure connected with the main body portion serves to position the weather seal with respect to the door frame. The leg structure has two legs which deflect slightly to grip two surfaces of the door frame, one the above-mentioned surface and another normal thereto. One of the legs may have apertures for fasteners to hold the seal in place.

U.S. Pat. No. 5,092,079 issued Mar. 3, 1992, by Brookman et al. for Weather Seal for a Garage Door discloses a weather seal for a garage door having a base member secured to a support surface. A block is pivotally connected to the base member for pivotal movement relative to the base member. A sealing lip is connected to the block and has a first position in the plane of the base member. The block includes a first triangular for engaging the support surface for pivotally moving the block and sealing lip at an angle to the base member when installed so that the sealing lip engages a door to effect a seal between the door and the sealing lip.

U.S. Pat. No. 5,784,834 issued Jul. 28, 1998, by Stutzman for Door Seal discloses a door seal particularly suitable for garage doors and has a rigid base portion made of a plastic material that is fastened to a support frame surrounding a door and a flexible combination cover and flap portion made of a plastic material that is integral with and preferably coextruded with the base portion. The cover and flap portion extend over outer front end and rear end faces of the base portion. The flap extends at an angle from a front corner along the outer face of the base portion. The flap extends forwardly and outwardly at an angle beyond the front end face of the base portion so as to be engaged and be flexed by the garage door in the closed position and in sealed engagement with the door when the door is closed.

U.S. Pat. No. 6,772,560 issued Aug. 10, 2004, by Dischiant et al. for Weather Strip for Doors discloses a sealing device for a door, and in particular for a garage door, for sealing the door and frame to facilitate the exclusion of elements, such as, for example, draughts, wind, rain, snow, insects, and the like, with a first part or base provided for mounting to a supporting surface, and a second part constructed to attach to the first part, the second part carrying a sealing element.

U.S. Pat. No. 6,772,561 issued Aug. 10, 2004, by Berger, Jr., for Garage Door Trim Assembly with Removable Sealing Element discloses a trim assembly having a longitudinally extending housing that is mounted against a structure or wall adjacent to a movable garage door. The housing includes a longitudinal bay in a first longitudinally extending wall. A longitudinally extending sealing member is removably mounted to the bay at one longitudinally extending side thereof and the distal longitudinal side of the sealing member co-acts with the garage door to provide a sealing slidable engagement thereon. The sending member is made out of resilient material such as rubber. A longitudinal slot is provided on a second wall of the housing opposite the first wall. The first wall including cooperating through openings aligned with the slot to permit fastening members to go through.

US D713,551 issued Sep. 16, 2014, by Kelly for Scalloped Exterior of a Garage Door Seal discloses a design for a scalloped exterior of a garage door seal.

U.S. Pat. No. 8,881,464 issued Nov. 11, 2014, by Huckeba for Weatherguard Door Sealing Device with Replaceable Seal discloses a weatherguard door sealing device comprising a single piece of metal with an outer leg, receiving leg, center section, first and second planar surfaces, first and second diagonal surfaces, and two inner reinforcing legs. The first planar surface connects the outer leg to the first diagonal surface, the first diagonal surface connects the center section to the first planar surface, the second planar surface connects the receiver leg to the second diagonal surface, and the second diagonal surface connects the center section to the second planar surface. The receiver leg comprises a receiver channel for receiving a sealing element. The two inner reinforcing legs are parallel to each other and extend perpendicularly from the center section. The thickness of the center section is greater than the thickness of the first and second planar surfaces and the first and second diagonal surfaces.

U.S. Pat. No. 9,045,937 issued Jun. 2, 2015, by Peck et al. for Garage Door Stop and Seal System discloses a garage door stop and seal system that allows for expansion and contraction, enables replacement of the seal, and provides hidden, or concealed, fasteners. The system includes a door stop that removeably snaps into a receiver, wherein the door stop conceals the fasteners used to connect the receiver to a door jamb. In addition, the door stop includes a receiving space for a replaceable seal.

U.S. Pat. No. 9,845,638 issued Dec. 19, 2017, by Cunningham for Garage Door Stop Mould discloses a garage door stop mold that comprises a base and a seal strip. The base mounts to a door jamb near a garage door opening. The seal strip attaches to the base. Tabs on the bottom surface of the seal strip insert into grooves extending from the base to attach the seal strip to the base. The seal strip has a door seal edge and a jamb seal edge. The door seal edge seals against a garage door when the door is closed and the jamb seal edge seals against the jamb.

U.S. Pat. No. 10,563,453 issued Feb. 18, 2020, by Steinke for Weatherstripping Assemblies for Garage Doors and Other Applications, Associated Apparatuses, and Associated Methods of Use discloses an apparatus which includes an elongate weatherstrip, which forms in cross-section a blade; a retainer connector adjacent a first face and partway between opposed ends of the blade; and one or more sealing members along a second face of the blade. A method includes installing a weatherstripping assembly on a door, window, door frame, or window frame, of a building or vehicle.

The object of the present invention is to provide a cost-effective replacement weather seal for an existing weather seal combination door stop and flexible seal. The replacement weather seal is easily transported because it is coilable. Additionally, the replacement weather seal is attached by hidden fasteners, protecting the fasteners from the weather, and making the final installation more aesthetically appealing.

### BRIEF SUMMARY OF THE INVENTION

The present invention is a garage door replacement weather seal comprising a planar main body having a bottom structure and a curb structure at a distal end of the bottom structure; a first leg; and a second leg; wherein the first leg and the second leg share a connection point on the main body at a proximal end of the bottom structure and extend away from the connection point on a same plane. The first leg is longer than the second leg and the first leg extends from the connection point from about 125° to about 145°, preferably at 135°, from the main body. The second leg is shorter than the first leg and the second leg extends from the connection point from about 35° to about 55°, preferably at 45°, from the main body. The curb structure is at a 90° angle to the bottom structure and aligns with a rear end wall of a weather seal base of an existing weather seal; wherein the main body is attached to an inner wall of the weather seal base of the existing weather seal with at least a hidden fastener.

In use, the first leg of the replacement weather seal is engageable with an exterior surface of a garage door, and the second leg of the replacement weather seal is engageable with a surface of a weather seal base of an existing weather seal. The main body, the first leg, and the second leg of the replacement weather seal are unitary and integrally molded from a flexible synthetic plastic polymer. The flexible synthetic plastic polymer enables the replacement weather seal to be coilable, paintable, and dyeable.

The replacement weather seal of the present invention replaces an existing weather seal by a method of removing a weather seal flexible flap from a weather seal base of the existing weather seal, wherein the existing seal is attached to a frame surface of a garage door frame of a garage door; aligning the curb structure of the replacement weather seal with a rear end wall of the weather seal base of the existing weather seal; and attaching the main body of the replacement weather seal to an inner wall of the weather seal base of the existing weather seal with at least a hidden fastener.

### BRIEF DESCRIPTION OF THE SEVERAL VIEWS OF THE DRAWINGS

FIG. 1 is a front elevation view of a garage having a garage door frame and a garage door, which door is in a closed position.

FIG. 2 is a top plan view of a garage door frame and a garage door, which garage door is in a closed position.

FIG. 3 is a perspective view (left drawing) of a weather seal, and a top plan, detailed view (right drawing) of a garage door, which garage door is in an open position, and a garage door frame having a weather seal.

FIG. 4 is a perspective view (left drawing) of a weather seal, and top plan, detailed view (right drawing) of a garage door, which garage door is in a closed position, and a garage door frame having a weather seal.

FIG. 5 is a perspective view of a replacement weather seal of the present invention.

FIG. 6 is a perspective view (left drawing) of a weather seal with a flexible flap removed, and a top plan, detailed view (right drawing) of a garage door, which garage door is in an open position, and a garage door frame having a weather seal with a flexible flap removed.

FIG. 7 is an exploded perspective view (left drawing) of a weather seal with a flexible flap removed and an uninstalled replacement weather seal of the present invention, and a top plan, detailed view (right drawing) of a garage door, which garage door is in an open position, and garage door frame having an uninstalled replacement weather seal of the present invention.

FIG. 8 is a perspective view (left drawing) of an installed replacement weather seal of the present invention, and top plan, detailed view (right drawing) of a garage door, which garage door is in a closed position, and a garage door frame having an installed replacement weather seal of the present invention.

### LIST OF REFERENCE NUMERALS

10 front elevation of a garage

11 garage door

12 garage door frame

13 garage door panels

14 garage door track

15 garage door exterior surface

16 garage frame surface

17 garage door interior wall surface

18 weather seal

19 weather seal base

20 weather seal flexible flap

21 front end wall of the weather seal base

22 rear end wall of the weather seal base

23 outer wall of the weather seal base

24 inner wall of the weather seal base

25 air gap

26 garage interior air space

27 garage exterior air space

28 replacement weather seal

29 replacement weather seal main body

30 replacement weather seal first leg

31 replacement weather seal second leg

32 replacement weather seal curb structure

33 replacement weather seal bottom structure

34 135° angle

35 45° angle

### DETAILED DESCRIPTION OF THE INVENTION

The present invention is a garage door replacement weather seal for use with existing garage doors having an existing two-part door seal. The existing two-part door seal has a rigid base portion, typically made of a plastic material, that is fastened to a support frame surrounding a garage door and a flexible combination cover and flap portion, typically made of a plastic material, that is integral with the base portion. The replacement weather seal replaces the flexible flap portion of the existing two-part door seal, and leaves the existing base portion fastened to the support frame. The replacement weather seal comprises a main body portion that attaches to the rigid base portion of the existing door weather seal. Flexible sealing flaps of the replacement weather seal are integrally molded to opposite edges of the main body portion and form a weather-tight seal with both the surface of the garage door and the surface of the existing base portion. An L-shaped curb structure connected with the main body portion serves to position the replacement weather seal with respect to the existing rigid base portion. The sealing flap structure of the replacement weather seal has two flaps which deflect slightly to grip surfaces of the garage door and the rigid base portion of the existing door seal.

The present invention provides a cost-effective, replacement weather seal for existing combination garage door stops and flexible seals. The replacement weather seal of the present invention can be easily transported because it is coilable. Additionally, the replacement weather seal of the present invention is attached by hidden fasteners, protecting the fasteners from the weather, and making the final installation aesthetically appealing.

The present invention provides a new and improved replacement weather seal for an existing garage door weather seal that utilizes an existing combination door stop and flexible flap. To use the replacement weather seal of the present invention, the existing flexible flap is removed from the existing combination garage door stop and weather seal, and the removed existing flexible flap portion is replaced with the replacement weather seal of the present invention, which is a coilable, flexible flap. The replacement weather seal of the present invention is attached with at least a hidden mechanical fastener, preferably a plurality of fasteners, to the existing door stop portion of the existing combination door stop and flexible flap. Furthermore, the mechanical fasteners are hidden from view when the garage door is in a closed position. Because the fasteners are hidden from view, the replacement weather seal of the present invention is aesthetically appealing.

The replacement weather seal of the present invention includes a planar main body portion which extends obliquely to a plane of a garage door, and which garage door plane is defined by an existing door stop portion of an existing combination door stop and flexible seal, or flap.

A pair of flexible flaps, or legs, form extensions of each edge of the main body portion, wherein a first leg, longer flexible sealing flap, seals the door stop portion of the existing combination door stop and flexible seal after the old flexible flap is removed; and a second leg, shorter flexible sealing flap, being longer than the first leg, engages an exterior surface of the garage door.

A generally L-shaped curb structure is integrally molded with the main body portion and serves to position the replacement weather seal of the present invention on the door stop portion of the existing combination door stop and flexible seal. The curb structure extends the full length of the main body portion ensuring proper placement of at least a mechanical fastener or multiple fasteners into the existing door stop portion of the existing combination door stop and flexible seal after the existing seal or flap portion has been removed.

As initially formed, both the first, longer leg and the second, shorter leg are on the same plane with the second, shorter leg, wherein the second leg extends at a preferred angle of 135° from the main body, extends rearwardly toward the garage door. Similarly, the first, longer leg extends at a preferred angle of 45° from the main body, and extends towards the doorstop portion of the existing doorstop and flexible weather seal after the flap has been removed.

However, upon installation, when the first leg and the second leg are pressed against the garage door and the base portion of the existing combination door stop and flexible weather seal, the angle between the first leg and the main body increases to greater than 135°, and the angle between the second leg and the main body increases to greater than 45°. The angles increase because the first leg and second leg structures are made of a flexible material, thus the first leg and the second leg both undergo elastic deformation, and seal tightly to the garage door and the existing base portion of the combination door stop and flexible seal.

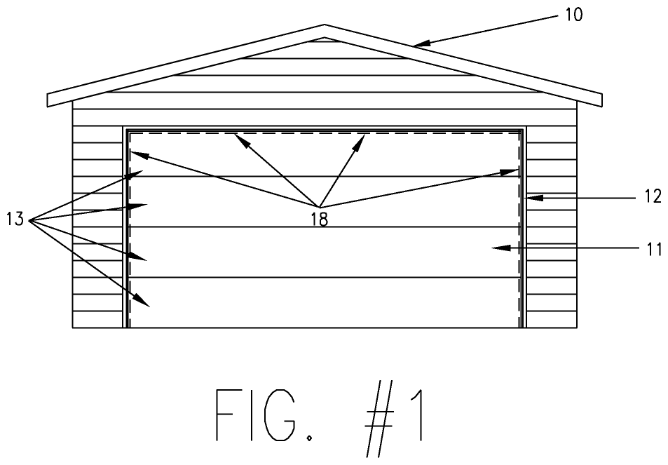

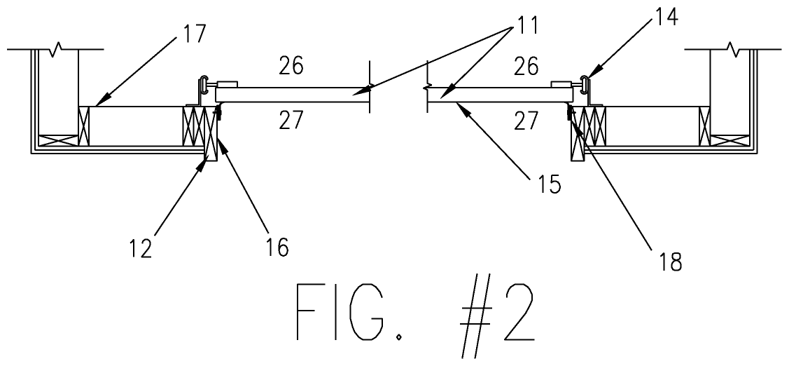

With reference to FIG. 1, shown is a front elevation view of a garage 10 having a garage door frame 12 and a garage door 11, which garage door 11 is in a closed position, and the garage door 11 is equipped with a flexible sealing flap weather seal 18 having a combination door stop and a flexible sealing flap as indicated by the dashed line 18. With reference to FIG. 1 and FIG. 2, FIG. 1 illustrates an existing garage 10 having an existing overhead garage door 11 fitted in a garage door frame 12. The garage door 10 is a conventional overhead garage door which may be segmented into a plurality of garage door panels 13 that run within tracks 14 as shown in FIG. 2, and which garage door panels 13 are arranged to move between a closed position, as shown in FIG. 1, and an open position. The garage door 11 is equipped with an existing combination door stop and flexible sealing flap weather seal 18 around the perimeter of the door frame 12.

With reference to FIG. 2, shown is a top plan view of a garage door 11 and garage door frame 12 equipped with a weather seal 18 comprising a combination door stop and flexible sealing flap in a closed position.

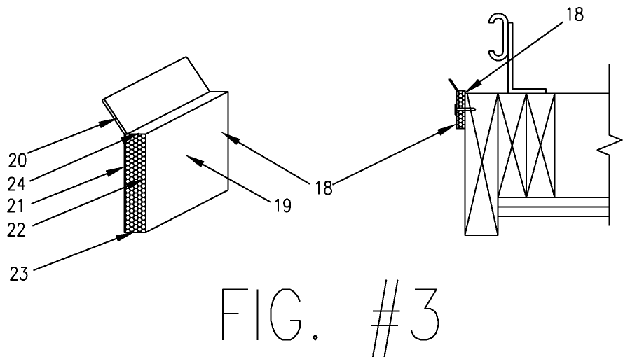

With reference to FIG. 3, shown is a perspective view (left drawing) and detailed view (right drawing) of a garage door 11 and garage door frame 12 equipped with weather seal 18 comprising a combination door stop and a flexible flap, with the garage door 11 in an open position. The existing weather seal 18 comprises a combination door stop and a flexible flap, which flap includes a weather seal base portion 19, and a combination cover and a weather seal flexible flap 20, which flap 20 is coextensive with the weather seal base portion 19. The weather seal base 19 is a rigid, straight, elongated body made, typically, of a plastic material and has a rectangular cross section comprising a front end wall of the weather seal base 21, a rear end wall of the weather seal base 22, an outer wall of the weather seal base 23, and an inner wall of the weather seal base 24. When the garage door 11 is in an open position, the weather seal flexible flap 20 is in a flat configuration and is at the flap's 20 original formation angle to the weather seal base portion 19.

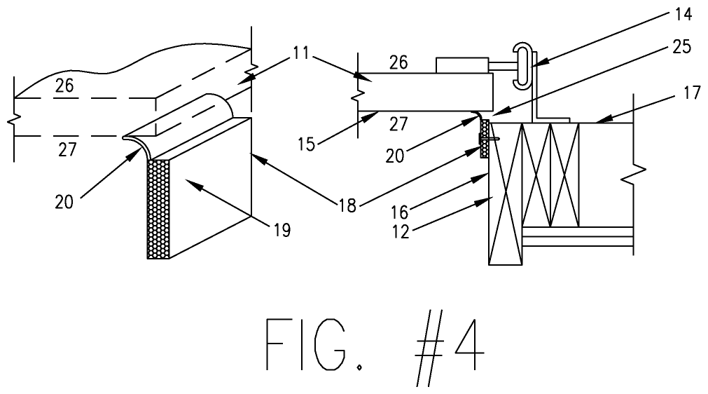

With reference to FIG. 4, shown is a perspective view (left drawing) of a prior art weather seal, and a top plan, detailed view (right drawing) of a garage door 11 in a closed position, and a garage door frame 12 equipped with a weather seal 18 comprising an existing combination door stop, or weather seal base 19, and a weather seal flexible flap 20, wherein the flexible flap 20 is touching a garage door exterior surface 15. When the garage door 11 is in a closed position, the flexible flap 20 of the weather seal 18 flexes and spans an air gap 25 between the garage door 11 and the garage door frame 12, and the flexible flap 20 prevents air flow between a garage interior air space 26 of the garage 10, and a garage exterior air space 27 of the garage door 11. When the garage door 11 is closed, the garage door exterior surface 15 generally defines a vertical plane having an interior garage wall surface 17. The garage door frame 12 typically is made of wood and includes a garage frame surface 16, which surface 16 is substantially perpendicular to the vertical plane defined by the garage door exterior surface 15 and the garage door interior wall surface 17, and which garage interior wall surface 17 is parallel to the garage door exterior surface 15.

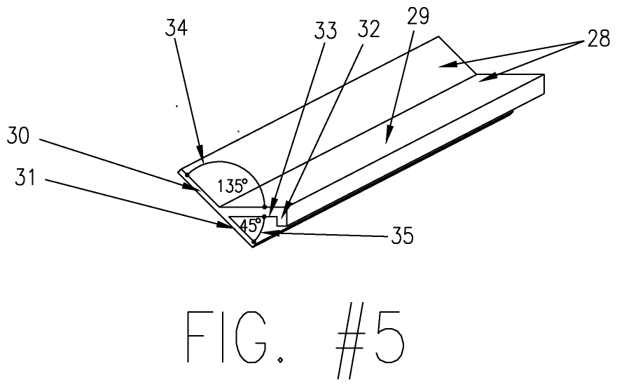

With reference to FIG. 5, shown is a perspective view of a replacement weather seal 28 of the present invention comprising a unitary flexible sealing flap in detail, which seal 28 is formed from a flexible synthetic plastic polymer, preferably polyvinyl chloride (PVC), and is coilable. The replacement weather seal 28 comprises a main body portion 29. Along opposite, axially extending edges of a proximal end a bottom structure 33 of the main body portion 29 is a pair of flexible sealing flaps, a first, longer leg 30 and second, shorter leg 31, which flaps 30, 31 are integrally molded with the main body portion 29 and generally form extensions of the main body portion 29. The first leg 30 and the second leg 31 share a same point of connection to the main body base 29 and extend away from the connection point on a same plane. The second leg 31 is engageable with a surface of the weather seal base 19 and the first leg 30 is engageable with an exterior surface 15 of a garage door 11. The flaps 30, 31, along with the main body 29, are formed of flexible PVC and are coilable. The first leg 30 is longer than the second leg 31, and extends from about 125° to about 145°, and preferably 135°, from the main body 29; and the second leg 31 is shorter than first leg 30, and extends from about 35° to about 55°, and preferably 45°, from the main body 29. The flexible sealing flaps 30, 31, run along an entire length of are molded integrally with the main body 29. Also integrally molded with the main body 29, and on the opposite side of the flexible sealing flap 31, is a curb structure 32 at a distal end of the bottom structure 33. The curb structure 32 is formed at about a 90° angle from bottom structure 33 of the main body 29, and like the flexible sealing flaps 30, 31, the curb structure 32 runs along the entire length of the main body 29.

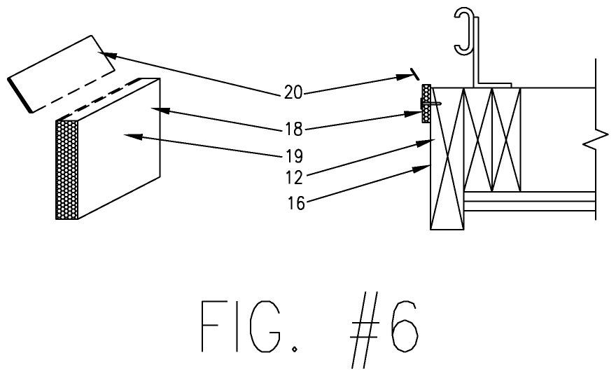

With reference to FIG. 6, shown is a perspective view (left drawing) of a weather seal 18 with a flexible flap 20 removed, and a top plan, detailed view (right drawing) of a garage door in an open position, and a garage door frame 12 having the weather seal 18 with the flexible flap 20 removed. Prior to installation of the replacement weather seal 28 of the present invention, the weather seal flexible flap 20 is removed from the weather seal base portion 19 of the weather seal 18. The removal is done with the existing base portion 19 still attached to the frame surface 16 of the existing garage door frame 12, and the removal of the flap 20 can be accomplished using common household tools, such as a box cutter, scissors, or other cutting implement.

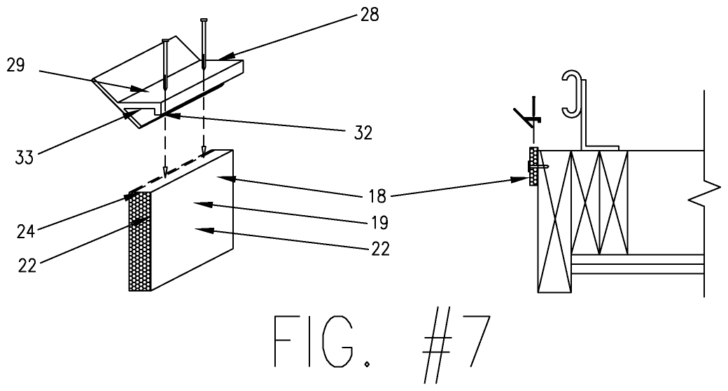

With reference to FIG. 7, shown is an exploded perspective view (left drawing) of a weather seal 18 with a flexible flap 20 removed and an uninstalled replacement weather seal 28 of the present invention; and a top plan, detailed view (right drawing) of a garage door, which garage door is in an open position, and the garage door frame having an uninstalled replacement weather seal of the present invention. When the replacement weather seal 28 is installed, a bottom structure 33 of the main body portion 29 is attached, preferably, mechanically, such as with fasteners, to an inner wall 24 of the weather seal base portion 19 of the weather seal 18. The curb structure 32 of the garage door replacement weather seal 28 is formed at about a 90° angle the bottom structure 33 and aligns the replacement weather seal 28 with the rear end wall 22 of the weather seal base portion 19 of the weather seal 18.

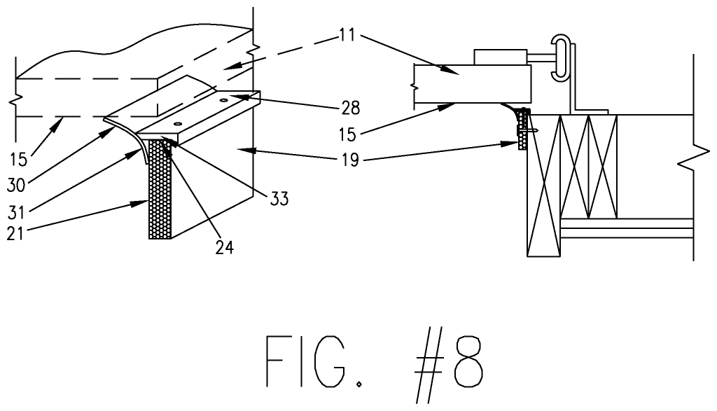

With reference to FIG. 8, shown is a perspective view (left drawing) of an installed replacement weather seal 28 of the present invention, and a top plan, detailed view (right drawing) of the garage door 11, which garage door 11 is in a closed position, and a garage door frame having an installed replacement weather seal 28 of the present invention. After the replacement weather seal 28 is installed on the weather seal base 19, then the second leg, shorter flexible sealing flap 31 presses against the front end wall 21 of the weather seal base portion 19 of the weather seal 18. Because the second leg, shorter flap 31 is made of flexible PVC, the second leg, shorter flap 31 slightly deflects and forms a tight seal against the front end wall of 21 of the weather seal base portion 19. When the garage door 11 is in the closed position, the first leg, longer flap 30 of the replacement weather seal 28 presses against the garage door exterior surface 15 of the garage door 11, and because the first leg, longer flap 30 is made of flexible PVC, the first leg, longer flap 30 slightly deflects and forms a tight seal against the garage door exterior surface 15 of the garage door 11.

After the replacement weather seal 28 is installed, it can be painted, if desired, for example, to match the garage door 11. Alternatively, the seal 28 can be painted before installation. Further alternatively, the seal 28 can be dyed during manufacturing and provided in a selection of pre-determined colors.

Unless defined otherwise, all technical and scientific terms used herein have the same meaning as commonly understood by one of ordinary skill in the art to which this invention belongs. Although the present invention has been described with reference to preferred methods and materials, and to specific embodiments, it is understood that modifications and variations of the present invention are possible without departing from the scope of the present invention, and that any methods and materials similar or equivalent to those described herein can also be used in the practice or testing of the present invention, which present invention is defined by the claims.

1. A garage door replacement weather seal, installed over a previously installed garage door weather seal, comprising:
a main body having a bottom surface;
a curb structure located along a distal end of the main body and oriented at a 90° angle to the bottom surface of the main body;
a first leg integral with the main body;
a second leg integral with the main body;
wherein the first leg and the second leg are on a same plane and extend in opposite directions from a connection point along a proximal end of the main body, wherein the first leg extends from the connection point at an angle from about 125° to about 145° from the main body, and the second leg extends from the connection point at an angle from about 35° to about 55° from the main body curb structure aligns the replacement weather seal with the previously installed garage door weather seal.

2. The garage door replacement weather seal, installed over a previously installed garage door weather seal, of claim 1, wherein the first leg is longer than the second leg.

3. The garage door replacement weather seal, installed over a previously installed garage door weather seal, of claim 1, wherein the first leg extends from the connection point at an angle 135° from the main body.

4. The garage door replacement weather seal, installed over a previously installed garage door weather seal, of claim 1, wherein the second leg is shorter than the first leg and extends from the connection point at an angle of 45° from the main body.

5. (canceled)

6. (canceled)

7. The garage door replacement weather seal, installed a previously installed garage door weather seal, of claim 1, wherein the curb structure aligns with a rear end wall of a weather seal base of the previously installed garage door weather seal.

8. The garage door replacement weather seal, installed over a previously installed garage door weather seal, of claim 1, wherein the first leg is engageable with an exterior surface of a garage door.

9. The garage door replacement weather seal, installed over a previously installed garage door weather seal, of claim 1, wherein the second leg is engageable with a surface of a weather seal base of weather seal.

10. The garage door replacement weather seal, installed over a previously installed garage door weather seal, of claim 1, wherein the main body is attached to an inner wall of a weather seal base of the previously installed garage door weather seal with at least one fastener that is hidden from view when a garage door is in a closed position.

11. The garage door replacement weather seal, installed over a previously installed garage door weather, of claim 1, wherein the main body, the first leg, and the second leg are unitary and integrally molded from a flexible synthetic plastic polymer.

12. The garage door replacement weather seal, installed over a previously installed garage door weather seal, of claim 11, wherein the replacement weather seal is coilable.

13. The garage door replacement weather seal, installed over a previously installed garage door weather seal, of claim 11, wherein the replacement weather seal is paintable.

14. The garage door replacement weather seal, installed over a previously installed garage door weather seal, of claim 11, wherein the replacement weather seal is dyeable.

15. A garage door replacement weather seal, installed over a previously installed garage door weather seal, comprising:
a main body having a bottom surface and a curb structure at a distal end of the main body, wherein the curb structure is at a 90° angle to the bottom surface;
a first leg longer than a second leg, wherein the first leg extends from a connection point along a proximal end of the main body from about 125° to about 145° from the main body;
the second leg is shorter than the first leg, and extends from the connection point along the proximal end of the main body from about 35° to about 55° from the main body;
wherein the first leg and the second leg are on a same plane and extend in opposite directions from the connection point along the proximal end of the main body; and
wherein the main body, the first leg, and the second leg are unitary and integrally molded 16 from a flexible synthetic plastic polymer.

16. The replacement weather seal, installed over a previously installed garage door weather seal, of claim 15, wherein the first leg extends from the connection point at an angle of 135° from the main body and the second leg extends from the connection point at an angle of 45° from the main body.

17. The replacement weather seal, installed over a previously installed garage door weather seal, of claim 15, wherein the curb structure aligns with a rear end wall of a weather seal base of the previously installed garage door weather seal.

18. The replacement weather seal, installed over a previously installed garage door weather seal, of claim 15, wherein the first leg is engageable with an exterior surface of a garage door.

19. The replacement weather seal, installed over a previously installed garage door weather seal, of claim 15, wherein the second leg is engageable with a surface of a weather seal base of the previously installed garage door weather seal.

20. The replacement weather seal, installed over a previously installed garage door weather seal, of claim 15, wherein the main body is attached to an inner wall of a weather seal base of the previously installed garage door weather seal with at least one fastener that is hidden from view when a garage door is in a closed position.

21. The replacement weather seal, installed over a previously installed garage door weather seal, of claim 15, wherein the replacement weather seal is coilable.

22. The replacement weather seal, installed over a previously installed garage door weather seal, of claim 15, wherein the replacement weather seal is paintable and dyeable.

23. Method of using a replacement weather seal for installing over a previously installed garage door weather seal comprising:
providing a replacement weather seal comprising a main body having a bottom surface and a curb structure at a distal end of the bottom surface, wherein the curb structure is at a 90° angle to the bottom surface; a first leg longer than a second leg, wherein the first leg extends from a connection point at an angle from about 125° to about 145° from the main body; and a second leg shorter than the first leg, and extends from a connection point at an angle from about 35° to about 55° from the main body; wherein the first leg and the second leg extend from a connection point on the main body at a proximal end of the bottom surface and extend away from the connection point on a same plane; and the main body, the first leg, and the second leg are unitary and integrally molded from a flexible synthetic plastic polymer;
removing a weather seal flexible flap from a weather seal base of the existing garage door weather seal, wherein the existing garage door weather seal is attached to a frame surface of a garage door frame of a garage door;
aligning the curb structure of the replacement weather seal with a rear end wall of the weather seal base of the existing garage door weather seal; and
attaching the main body of the replacement weather seal to an inner wall of the weather seal base of the existing garage door weather seal with at least one hidden fastener.
